(19) United States
(12) Patent Application Publication
(10) Pub. No.: US 2019/0288832 A1
(43) Pub. Date: Sep. 19, 2019

(54) SEPARATION OF TRANSACTION AND ACCOUNT DATA IN BLOCKCHAINS

(71) Applicant: Wei Kang Tsai, Irvine, CA (US)

(72) Inventors: Enyan Dang, Irvine, CA (US); Wei-Tek Tsai, Irvine, CA (US); Wei Kang Tsai, Irvine, CA (US)

(21) Appl. No.: 16/352,831

(22) Filed: Mar. 14, 2019

Related U.S. Application Data
(60) Provisional application No. 62/643,025, filed on Mar. 14, 2018.

(51) Int. Cl. H04L 9/08; H04L 29/06; H04L 9/06; H04L 9/32

(52) U.S. Cl. CPC H04L 9/085; H04L 63/061; H04L 2209/38; H04L 9/3242; H04L 2209/56; H04L 9/0637

(57) ABSTRACT

A method of for improving performance scalability of an application blockchain system in which application data are organized according to accounts, and changes in application data are caused by account transactions. A composite blockchain system comprises 2 types of subsystem blockchains: an ABC (account blockchain) type stores detailed account data for a set of accounts, and a TBC (transaction blockchain) type stores data necessary to perform account transactions for a set of accounts. A TBC chain writes account data into an ABC chain, and a TBC chain reads account data from an ABC chain.

### CROSS REFERENCES TO RELATED APPLICATIONS

The present application claims priority to U.S. Provisional Patent Application No. 62/643,025 entitled “A System Having a Transaction Blockchain and a Separate Account Blockchain,” filed on Mar. 14, 2018, which is hereby incorporated by reference in its entirety.

### FIELD OF THE INVENTION

The present invention relates to blockchain systems wherein application data are organized into accounts, and in particular, to blockchain systems wherein application account data are subject to dynamic changes due to account transactions.

### BACKGROUND OF THE INVENTION

A basic application of blockchain is dynamic database. Usually data in the database is organized into accounts, and dynamic data changes are caused by account transactions, or transactions involving individual accounts. There are numerous blockchain applications wherein data are organized into accounts, and these applications cover practically all segments of a modern society. They include, but are not limited to, healthcare, manufacturing, financial services, government services, industries of all types, charity, agriculture, retail, real estate, tourism, transportation, media, etc. While the present invention is described via financial services, in particular, banking and security trading as exemplary applications, the present invention is not limited to financial asset trading.

A significant issue with existing blockchain systems is poor performance scalability: as the total number of accounts grows, updating account information in account transactions becomes slower. This is an issue that has hindered widespread adoption of blockchain in the financial services industry. In a financial service institution, all information stored in an account is important—losing or altering even a minute bit of account information is unacceptable. At the same time, complex financial business needs lead to an enormous amount of account data. For instance, a bank system would store in each account purchasing status, credit information, income, etc. If the entire account data is stored in a blockchain, when the number of accounts gets larger, each node in the blockchain not only has to maintain a large amount of account data, but also process account transactions in order to build a new block (in the blockchain). When the total data amount (in the blockchain) is increased, the search time to locate a particular account record is increased, thereby causing delay in processing an account transaction.

A problem lies with the way current blockchain systems organize and store their account data. For example, both Bitcoin and Ethereum store transaction data and account data within the same blockchain. Bitcoin uses UTXO (unspent output from bitcoin transactions) to store each account's unspent transaction output. When querying an account's data, it is necessary to search all blocks (in the blockchain) containing transactions involving the account. Ethereum uses Merkle Patricia Tree as an index to speed up account information search. These methods of storing and searching data are not performance scalable, when the total data amount in the entire chain is large.

### BRIEF SUMMARY OF THE INVENTION

Aspects of the present invention relate to providing methods for improving performance scalability of an application blockchain system in which application data are organized according to accounts, and changes in application data are caused by account transactions involving individual accounts. By performance, it is meant the speed of processing a set of account transactions and storing the results of these transactions in the accounts stored in the blockchain system.

In accordance with one aspect of the present invention, application data are stored in 2 types of blockchains, wherein the first type, referred to as ABC (short for account blockchain), stores detailed account data for a set of accounts; and the second type, referred to as TBC (short for transaction blockchain), stores data necessary to perform account transactions for a set of accounts. Hereafter, a blockchain of ABC type will be referred to as an ABC chain, and a blockchain of TBC type will be referred to as a TBC chain. Further, a node in an ABC chain will be referred to as an ABC node, and a node in a TBC chain will be referred to as a TBC node.

In accordance with one aspect of the present invention, a TBC chain writes account data into an ABC chain, and a TBC chain reads account data from an ABC chain.

In accordance with one aspect of the present invention, a plurality of TBC nodes and ABC nodes work together to form a complete blockchain node.

In accordance with one aspect of the present invention, a plurality of ABC chains and a plurality of TBC chains can work together as a composite blockchain system, wherein each of the ABC chains and the TBC chains is a subsystem blockchain of the composite blockchain system. In this specification, a composite blockchain system is alternately known as a network of blockchains. A simple composite blockchain system comprises a single ABC chain and a single TBC chain.

Optionally, a composite blockchain system or a network of blockchains includes a subsystem blockchain which is neither an ABC chain nor a TBC chain.

In accordance with one aspect of the present invention, each component or subsystem chain in a composite blockchain system is a blockchain system independent of other component blockchains in the composite system. Each component chain, either of the type ABC or TBC, builds its blocks and maintains its blocks, independently of other component chains in the composite system. In building a new block, a subsystem chain accepts a set of blockchain transactions, wherein a blockchain transaction is an atomic event allowed by the underlying protocol to update the data in a blockchain. Therefore, technically, an account transaction is different from a blockchain transaction. To perform an account transaction, a TBC chain may retrieve account data sent from an ABC chain, thereby allowing the TBC chain to process an account transaction.

In accordance with one aspect of the present invention, when a TBC chain receives an account transaction request, it sends a request to an ABC chain, via account IDs, to receive account data associated with participating accounts in the requested transaction. This process may be needed to validate and process the requested account transaction. After the TBC chain completes the account transaction, it sends an update message to an ABC chain to update account data in a participating account.

In accordance with one aspect of the present invention, after an ABC chain receives an account update request from a TBC chain, the ABC chain updates its accounts according to the update request received.

In accordance with one aspect of the present invention, a TBC component chain and an ABC component chain can employ the same underlying chain protocols, block-building algorithms, and chain-maintenance algorithms.

In accordance with one aspect of the present invention, a TBC node and an ABC node can share the same physical computing facility, wherein the two nodes can be implemented either by separate physical machines or by separate virtual machines.

### BRIEF DESCRIPTION OF THE DRAWINGS

The above and other objects and features in accordance with the present invention will become apparent from the following descriptions of embodiments in conjunction with the accompanying drawings, and in which:

FIG. 1 is a simplified illustration that shows an ABC chain and a TBC chain working together to process a transaction request, in one exemplary embodiment of the present invention.

FIG. 2 is a simplified illustration that shows a network of blockchains with an ABC chain and two TBC chains, in one exemplary embodiment of the present invention.

FIG. 3 is a simplified illustration that shows how a composite blockchain system is formed by a single ABC chains with a number of TBC chains in 3 configurations, in one exemplary embodiment of the present invention.

FIG. 4 is a simplified illustration that shows how a composite blockchain system is formed by a plurality of ABC chains and TBC chains in a financial market application, with a regulatory blockchain system, in one exemplary embodiment of the present invention.

FIG. 5 is a simplified illustration that shows how a composite blockchain system is formed by a plurality of ABC chains and TBC chains in a clearing-house application, with 2 regulatory blockchain systems, a group of exchange blockchains, and a group bank blockchains, in one exemplary embodiment of the present invention.

FIG. 6 is a simplified illustration that shows how an ABC chain can be split into a number of smaller ABC chains, in one exemplary embodiment of the present invention.

### DETAILED DESCRIPTION OF EXEMPLARY EMBODIMENTS

In one embodiment of the present invention, an ABC type blockchain stores full account data for a set of accounts in an application, whereas a TBC blockchain stores necessary data for a set of accounts for the purpose of processing an account transaction.

In one embodiment of the present invention, a composite blockchain system comprises one ABC subsystem chain and one TBC subsystem chain. Optionally, in this composite system, a system node comprises 2 nodes: one ABC node of the ABC chain, and one TBC node of the TBC chain.

When a TBC chain receives an account transaction request, it sends an account data request to an ABC chain, via account IDs, to receive account data for the accounts involved in the requested transaction. Using received account data from the ABC chain, the TBC chain validates and processes the requested transaction. After the TBC chain has completed the requested transaction, it sends account-updating data to the ABC chain, and the ABC chain updates the accounts involved in the requested transaction in its data store, according to the data received from the TBC chain.

In one embodiment of the present invention, an ABC chain is split into a plurality of subcomponent ABC chains, wherein each subcomponent ABC chain stores a subset (a partial portion) of the entire account data from the ABC chain. The splitting allows a composite blockchain system to perform load balancing and/or speed up account transactions.

In one embodiment of the present invention, a privileged ABC or TBC chain is included as a subsystem blockchain of a multi-blockchain system, and the privileged ABC or TBC chain is allowed to request and receive requested data from a subset of ABC and/or TBC chains of the multi-blockchain system. In regulated industry applications, the privileged ABC or TBC chains can be agents of government regulatory bodies. In financial applications, a privileged ABC or TBC could serve as a real-time monitoring and regulating system for the SEC (securities and exchange commission) or the Federal Reserve.

In one embodiment of the present invention, a privileged subsystem ABC or TBC chain of a multi-blockchain system, through pre-arranged mechanisms, receives data, without making requests, from a subset of ABC and/or TBC chains of the multi-blockchain system. The receiving of data can be done in real-time. In some embodiments, a privileged TBC is able to modify an account transaction, the modification contradicting the originally requested account transaction in scope or in quantity. The privileged chains could be useful in not only financial applications, but also non-financial applications of all types.

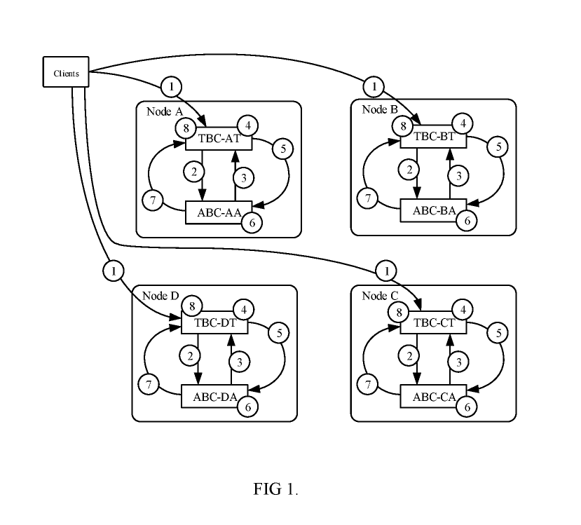

Reference is now made to FIG. 1, which is a simplified illustration showing an ABC chain and a TBC chain working together to process a transaction request, in one exemplary embodiment of the present invention. In this illustration, there are 4 nodes in the ABC chain (AA, BA, CA, and DA), and there are 4 nodes in the TBC chain (AT, BT, CT, and DT). The 4 nodes in the ABC chain are labelled in FIG. 1 as ABC-AA, ABC-BA, ABC-CA, and ABC-DA respectively. The 4 nodes in the TBC chain are labelled in FIG. 1 as TBC-AT, TBC-BT, TBC-CT, and TBC-DT respectively. In the FIG. 1, node A comprises TBC-AT and ABC-AA; node B comprises TBC-BT and ABC-BA; node C comprises TBC-CT and ABC-CA; node D comprises TBC-DT and ABC-DA. A procedure for completing an account transaction is stated as follows:

Step (1): each of the nodes in the TBC chain receives a transaction request from a client.

Step (2): node AT sends a request to node AA to obtain account data; node BT sends a request to node BA to obtain account data; node CT sends a request to node CA to obtain account data; node DT sends a request to node DA to obtain account data.

Step (3): node AT receives account data from node AA; node BT receives account data from node BA; node CT receives account data from node CA; node DT receives account data from node DA.

Step (4): nodes AT, BT, CT, and DT together process the transaction, according to the account data received from nodes AA, BA, CA, and DA, as a blockchain system.

Step (5): node AT sends a request to node AA to update account data; node BT sends a request to node BA to update account data; node CT sends a request to node CA to update account data; node DT sends a request to node DA to update account data.

Step (6): nodes AA, BA, CA, and DA together update account data, according to the update data received from nodes AT, BT, CT, and DT, as a blockchain system.

Step (7): node AA sends a confirmation to node AT that the requested account update is completed; node BA sends a confirmation to node BT that the requested account update is completed; node CA sends a confirmation to node CT that the requested account update is completed; node DA sends a confirmation to node DT that the requested account update is completed.

Step (8): nodes AT, BT, CT, and DT together confirm account data update, according to the confirmation messages received from nodes AA, BA, CA, and DA, as a blockchain system.

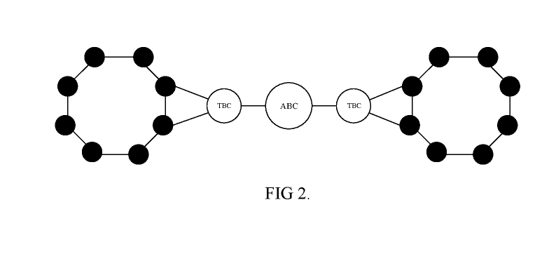

Reference is now made to FIG. 2, which is a simplified illustration showing a network of blockchains with an ABC chain and two TBC chains, in one exemplary embodiment of the present invention. In this embodiment, the black nodes in FIG. 2 represent other blockchain systems connected to the network of blockchains. The blockchain systems represented by the black nodes are not restricted to be of either ABC or TBC type.

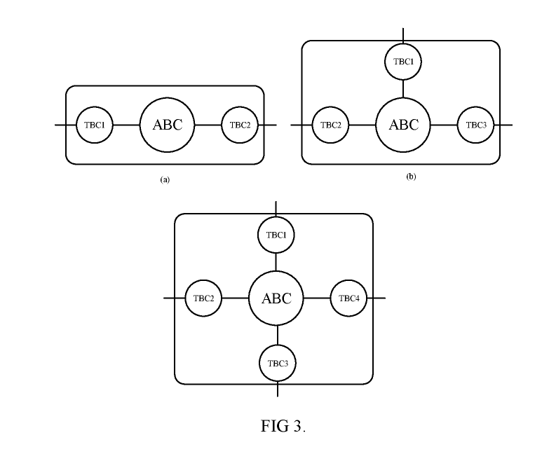

Reference is now made to FIG. 3, which is a simplified illustration showing how a composite blockchain system is formed by a single ABC chains with a number of TBC chains in 3 configurations, in one exemplary embodiment of the present invention. In configuration (a), an ABC chain is connected to 2 TBC chains (TBC1 and TBC2); in configuration (b), an ABC chain is connected to 3 TBC chains (TBC1, TBC2, and TBC3); in configuration (c), an ABC chain is connected to 4 TBC chains (TBC1, TBC2, TBC3, and TBC4).

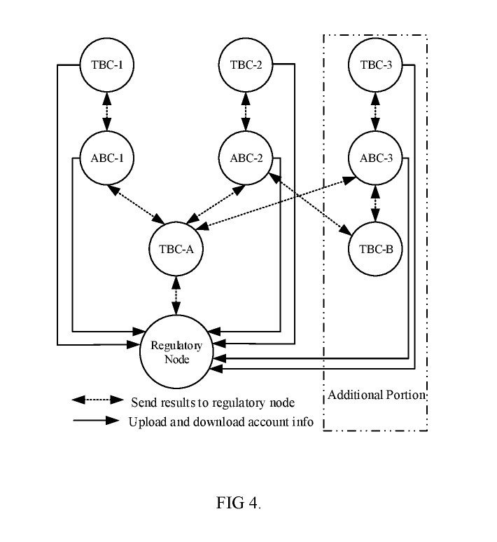

Reference is now made to FIG. 4, which is a simplified illustration showing how a composite blockchain system is formed by a plurality of ABC chains and TBC chains in a financial market application, with a regulatory blockchain system, in one exemplary embodiment of the present invention. In this embodiment, the regulatory node (part of a regulating blockchain system) is authorized to upload and download data directly with each of the 3 TBC chains (TBC-1, TBC-2, and TBC-3), and each of 3 ABC chains (ABC-1, ABC-2, and ABC-3). Further, 2 TBC chains (TBC-A and TBC-B) are authorized to request and receive regulatory data from a restricted set of other chains. In FIG. 4, TBC-3, ABC-3, and TBC-B form an “additional portion” of the entire system—they serve as a backup subsystem for the rest of the composite system.

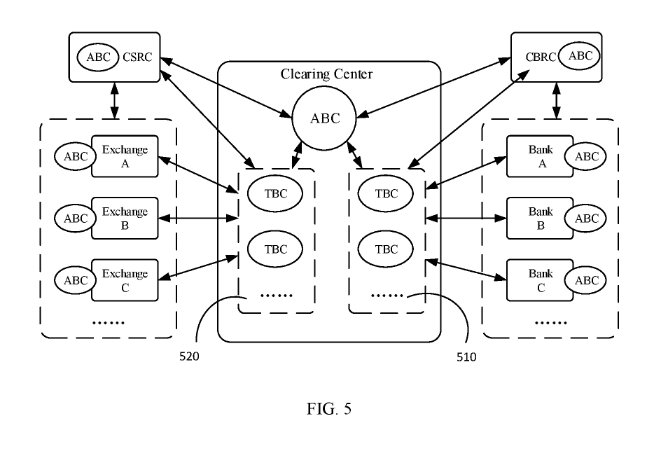

Reference is now made to FIG. 5, which is a simplified illustration showing how a composite blockchain system is formed by a plurality of ABC chains and TBC chains in a clearing-house application. In this embodiment, the clearing house (labelled as the clearing center in the figure) is a composite blockchain system comprising an ABC chain, and 2 groups (the left group 520 and right group 510 in the figure) of TBC chains. The left group of TBC chains are connected to a group of exchange system blockchains (each represented by an ABC chain, such as exchange A, exchange B, and exchange C). The right group of TBC chains are connected to a group of bank system blockchains (each represented by an ABC chain, such as bank A, bank B, and bank C). The group of exchange system blockchains is connected to a central regulatory node, represented by the CSRC (central security regulatory commission) ABC chain. The group of bank system blockchains is connected to a central regulatory node, represented by the CBRC (central bank regulatory commission) ABC chain.

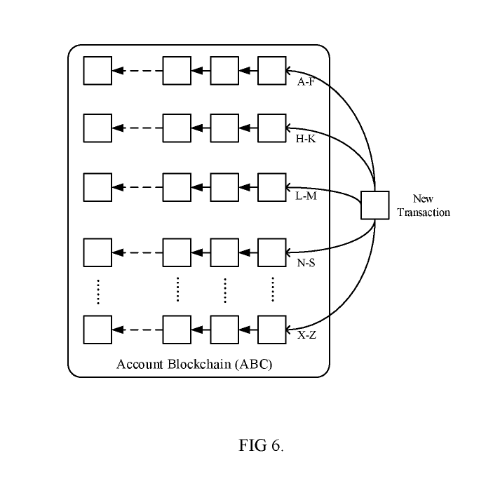

Reference is now made to FIG. 6, which is a simplified illustration showing how an ABC chain can be split into a number of smaller ABC chains, in one exemplary embodiment of the present invention. In this embodiment, a large ABC chain is decomposed into a group of ABC chains, represented by the chains A-F, H-K, L-M, N-S, X-Z, etc. The decomposition is by lexicographic ordering; for example, chain A-F stores all accounts starting with the letter A through F in account name. Such a splitting allows an ABC chain (similarly, a TBC chain), a composite blockchain system, or a network of blockchains to perform load balancing, or to speed up transaction speed.

What is claimed is:

1. A multi-blockchain system with a plurality of subsystem blockchains, each subsystem blockchain functioning as an independent blockchain collaborating with other subsystem blockchains, the subsystem blockchains comprising at least 2 types, referred to as ABC chains and TBC chains, wherein:
an ABC chain stores data organized according to accounts;
a TBC chain stores data organized according to accounts;
to process an account transaction, an ABC chain sends account data to a TBC chain, thereby allowing the TBC chain to use the account data received from the ABC chain to process the account transaction; and
to complete an account transaction, a TBC chain sends an account update to an ABC chain, thereby allowing the ABC chain to update its account data.

2. The multi-blockchain system of claim 1, wherein a system node in the multi-blockchain system comprises at least a first blockchain node associated with an ABC chain, and a second blockchain node associated with a TBC chain.

3. The multi-blockchain system of claim 1, wherein a TBC chain uses account data sent from an ABC to validate an account transaction request.

4. The multi-blockchain system of claim 1, wherein an ABC chain is split into a plurality of subcomponent ABC chains, wherein each subcomponent ABC chain stores a subset of account data from the ABC chain.

5. The multi-blockchain system of claim 1, wherein a privileged ABC or TBC chain is a subsystem blockchain of the multi-blockchain system, and the privileged ABC or TBC chain is allowed to request and receive requested data from a subset of ABC and/or TBC chains of the multi-blockchain system.

6. A method of operating a multi-blockchain system with a plurality of subsystem blockchains, each subsystem blockchain functioning as an independent blockchain collaborating with other subsystem blockchains, the subsystem blockchains comprising at least 2 types, referred to as ABC chains and TBC chains, wherein:
an ABC chain stores data organized according to accounts;
a TBC chain stores data organized according to accounts;
to process an account transaction, an ABC chain sends account data to a TBC chain, thereby allowing the TBC chain to use the account data received from the ABC chain to process the account transaction; and
to complete an account transaction, a TBC chain sends an account update to an ABC chain, thereby allowing the ABC chain to update its account data.

7. The method of claim 6, wherein a system node in the multi-blockchain system comprises at least a first blockchain node associated with an ABC chain, and a second blockchain node associated with a TBC chain.

8. The method of claim 6, wherein a TBC chain uses account data sent from an ABC to validate an account transaction request.

9. The method of claim 6, wherein an ABC chain is split into a plurality of subcomponent ABC chains, wherein each subcomponent ABC chain stores a subset of account data from the ABC chain.

10. The method of claim 6, wherein a privileged ABC or TBC chain is a subsystem blockchain of the multi-blockchain system, and the privileged ABC or TBC chain is allowed to request and receive requested data from a subset of ABC and/or TBC chains of the multi-blockchain system.

11. A multi-blockchain system with a plurality of subsystem blockchains, each subsystem blockchain functioning as an independent blockchain collaborating with other subsystem blockchains, the subsystem blockchains comprising at least 3 types, referred to as ABC chains, TBC chains, and privileged chains, wherein:
an ABC chain stores data organized according to accounts;
a TBC chain stores data organized according to accounts;
to process an account transaction, an ABC chain sends account data to a TBC chain, thereby allowing the TBC chain to use the account data received from the ABC chain to process the account transaction;
to complete an account transaction, a TBC chain sends an account update to an ABC chain, thereby allowing the ABC chain to update its account data; and
a privileged chain receives data from a subset of the subsystem blockchains, with or without making a request.

12. The multi-blockchain system of claim 11, wherein a system node in the multi-blockchain system comprises at least a first blockchain node associated with an ABC chain, and a second blockchain node associated with a TBC chain.

13. The multi-blockchain system of claim 11, wherein a TBC chain uses account data sent from an ABC to validate an account transaction request.

14. The multi-blockchain system of claim 11, wherein an ABC chain is split into a plurality of subcomponent ABC chains, wherein each subcomponent ABC chain stores a subset of account data from the ABC chain.

15. The multi-blockchain system of claim 11, wherein a privileged chain is either an ABC or a TBC chain.

16. The multi-blockchain system of claim 11, wherein a privileged chain receives data from a subset of subsystem blockchains in real time.

17. The multi-blockchain system of claim 11, wherein a privileged chain is allowed to modify a requested account transaction in scope or in quantity.
